(19) United States
(12) Patent Application Publication
(10) Pub. No.: US 2014/0053063 A1
(43) Pub. Date: Feb. 20, 2014

(54) USER INTERFACE CONTROL FRAMEWORK FOR STAMPING OUT CONTROLS USING A DECLARATIVE TEMPLATE

(71) Applicants: Cory Cirrincione, Bellevue, WA (US); Mark Leece, Bellevue, WA (US); Dominic Hopton, Redmond, WA (US)

(72) Inventors: Cory Cirrincione, Bellevue, WA (US); Mark Leece, Bellevue, WA (US); Dominic Hopton, Redmond, WA (US)

(73) Assignee: MICROSOFT CORPORATION, Redmond, WA (US)

(21) Appl. No.: 13/584,936

(22) Filed: Aug. 14, 2012

(51) Int. Cl. G06F 17/00

(52) U.S. Cl. 715/235; 715/234

(57) ABSTRACT

A user interface (“UI”) control framework enables UI controls to be declaratively created inline with the HTML markup without having to write boilerplate JavaScript that would usually be needed with conventional UI control models. The UI control framework is architected to sit on top of existing WinJS (Windows Library for JavaScript) functionality and encapsulates behaviors that are common across many control implementations so that a single instance of a UI control template may be used to stamp out multiple control instances. The UI control framework separates layout from the “code behind” in the backing controls so that data binding can be implemented abstractly without explicit knowledge of the layout of the control and any of its child controls. The markup provides “anchor points” that allow the code to have direct access to a child control. Custom expando HTML attributes are utilized that place named properties on control instances.

### BACKGROUND

The fifth revision of the HyperText Markup Language, named “HTML5,” is formally defined by an international standards body known as the World Wide Web Consortium (“W3C”). HTML5 includes more than 100 specifications that relate to the next generation of Web technologies. HTML5 describes a set of HTML, CSS (Cascading Style Sheets), and JavaScript specifications configured to enable designers and developers to build the next generation of web sites and applications. While such technologies perform satisfactorily in many usage scenarios, opportunities still exist for enhanced and richer web application development experiences to be implemented.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A user interface (“UI”) control framework enables UI controls to be declaratively created inline with the HTML markup without having to write boilerplate JavaScript that would usually be needed with conventional UI control models. In one particular illustrative embodiment, the UI control framework is architected to sit on top of existing WinJS (Windows Library for JavaScript) functionality and encapsulates behaviors that are common across many control implementations so that a single instance of a UI control template may be used to stamp out multiple control instances. The UI control framework separates layout from the “code behind” in the backing controls so that data binding can be implemented abstractly without explicit knowledge of the layout of the control and any of its child controls. The markup provides “anchor points” that allow the code to have direct access to a child control. Custom expando HTML attributes are utilized that place named properties on control instances.

Advantageously, the loose coupling between the layout and backing controls allows UI controls to be readily created by web application designers who tend to be specialists in HTML and CSS but who may not be as conversant in JavaScript coding as programmers/developers. The framework supports declarative creation of UI controls without the designer having to touch the backing control code. The framework and its declarative templates are further inherently flexible so that designers can make large scale changes to control layout so long as the anchor points remain named the same without triggering a need to update code in the backing controls. Such flexibility provides powerful tools for application designers to produce rich user experiences while also reducing expenses associated with code maintenance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which the present UI control framework may be implemented;

FIG. 2 shows how a UI control layout is tightly coupled to the underlying “code behind” in a traditional UI control model;

FIG. 3 shows an illustrative HTML code that invokes a UI control that displays music tracks and enables their purchase;

FIG. 4 shows an illustrative example of boilerplate JavaScript used to implement the UI control shown in FIG. 3;

FIG. 5 shows how a markup file that specifies UI control layout is loosely coupled and separated from the backing control in the present UI control framework;

FIG. 6 shows an illustrative example of how a declarative UI control template is used to “stamp out” multiple control instances;

FIG. 7 shows an illustrative arrangement for binding data to controls in a layout in which the data is provided by a backing control;

FIG. 8 shows an illustrative architecture for an implementation of the present UI control framework;

FIG. 9 shows creation of a namespace and functions supporting the present UI control framework under WinJS;

FIGS. 10-12 show an example of an illustrative usage of the present UI control framework;

FIG. 13 shows a portion of an illustrative HTML DOM (Document Object Model) tree;

FIGS. 14-17 show illustrative HTML fragments that include various expando attributes associated with HTML elements; and

FIG. 18 is a simplified block diagram of an illustrative computer system such as a personal computer or server with which the present UI control framework may be implemented.

Like reference numerals describe like elements in the drawings.

### DETAILED DESCRIPTION

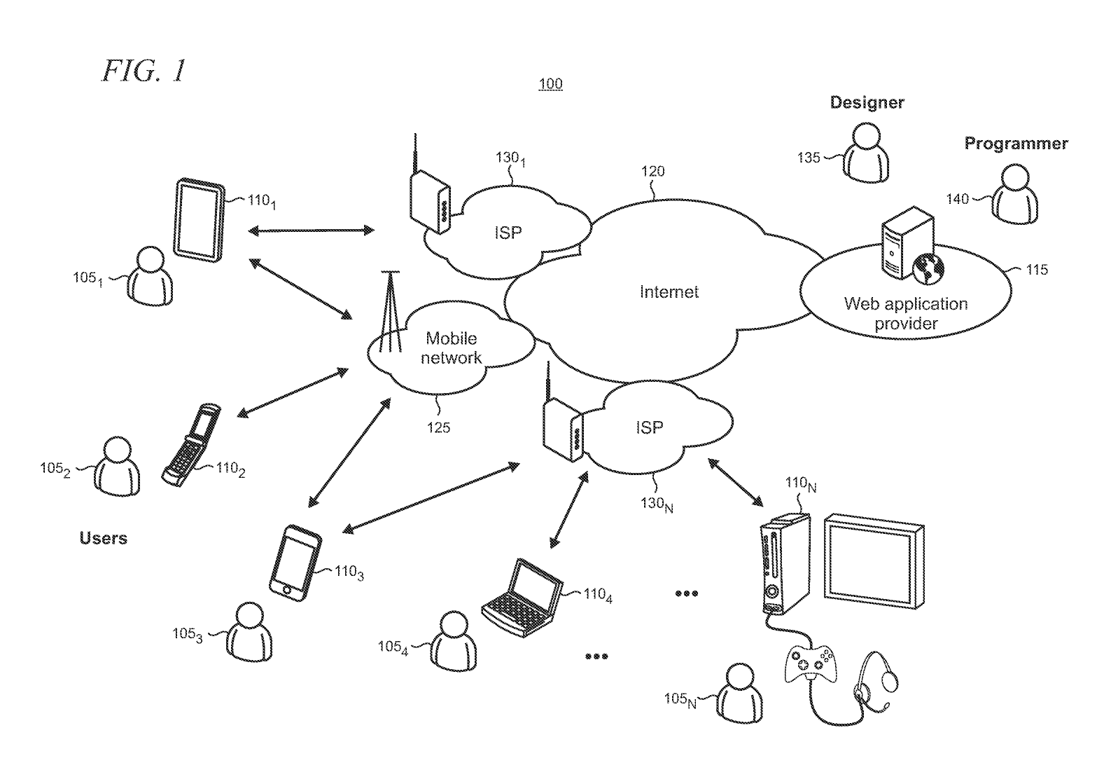

FIG. 1 shows an illustrative computing environment 100 in which the present UI control framework may be implemented. In the environment 100, a number of web application users 105 employ respective computing devices 110 to access web-based resources including a web application provider 115 over the Internet 120. The computing devices 110 can comprise a variety of platforms having various features and functionalities (where not all of such platforms are illustrated in FIG. 1) including, for example, mobile phones, smart phones, personal computers (“PCs”), ultra-mobile PCs, PDAs (personal digital assistants), e-mail appliances, digital media players, tablet computers, handheld gaming platforms and gaming consoles, notebook and laptop computers, Internet-connected televisions, set-top boxes, GPS (Global Positioning System) and navigation devices, digital cameras, and devices having various combinations of functionalities provided therein. It is emphasized, however, that the preceding list is intended to be illustrative, and that the present arrangement can be expected to be utilized on any of a variety of platforms that support HTML5 functionalities or a subset thereof.

While not a required functionality to implement the present UI control framework, the computing devices 110 may often have some form of network connectivity feature, either directly or through an intermediary device (e.g., an Internet-connected personal computer), as well as a web browser or application or embedded features that provide similar functionality which operates on the device and supports user interactivity through a display and input device such as a touchscreen, keypad, pointing device, and the like. As shown in FIG. 1, the computing devices 110 may access the Internet 120 and the web application provider 115 using a mobile network 125, or through Internet Service Providers (“ISPs”) 130, or using both in some cases.

A web application designer 135 works with the provider 115 to design next generation web technologies including applications and websites that leverage the capabilities of HTML5. A programmer 140 also works with the provider. In this illustrative example, the designer is typically familiar with, and uses HTML and CSS and does not necessarily have the same high level of expertise in coding as the programmer.

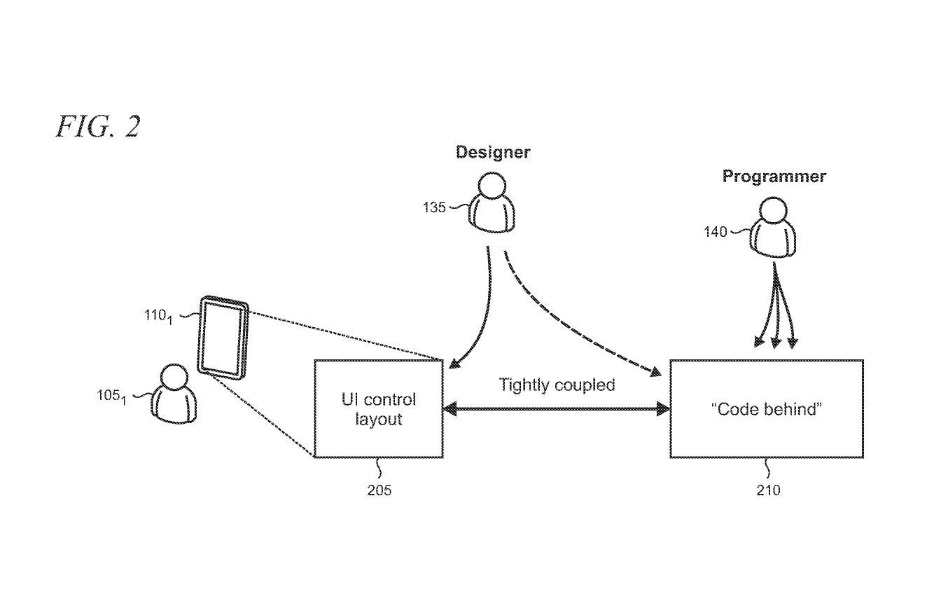

As shown in FIG. 2, traditional UI control development models often implement a tight coupling between the UI control layout 205 that organizes and presents the controls on the display for the user and the underlying code 210 (often termed “code behind”) that is utilized to implement the controls using the business and/or presentation logic of the web application. Such tight coupling means that the code needs to have explicit knowledge of the layout of each UI control and any child controls. In addition, any dependencies owned by a child control needs to be explicitly managed by the parent.

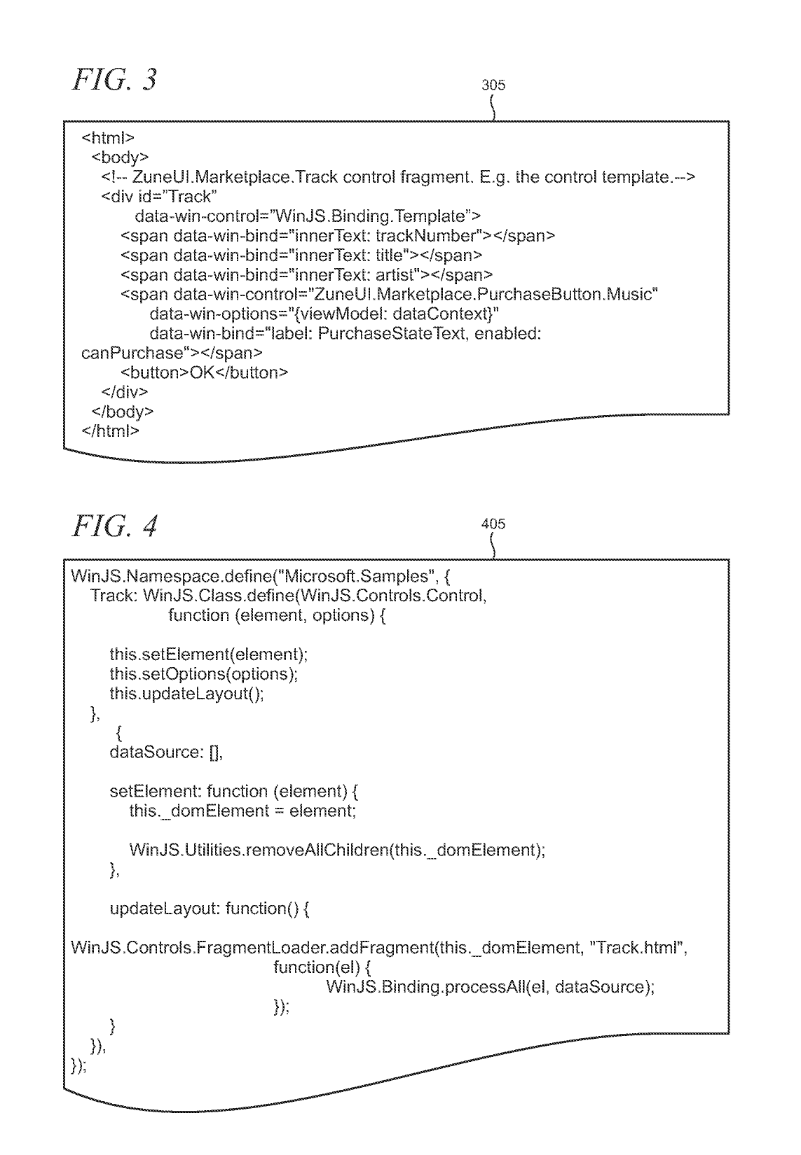

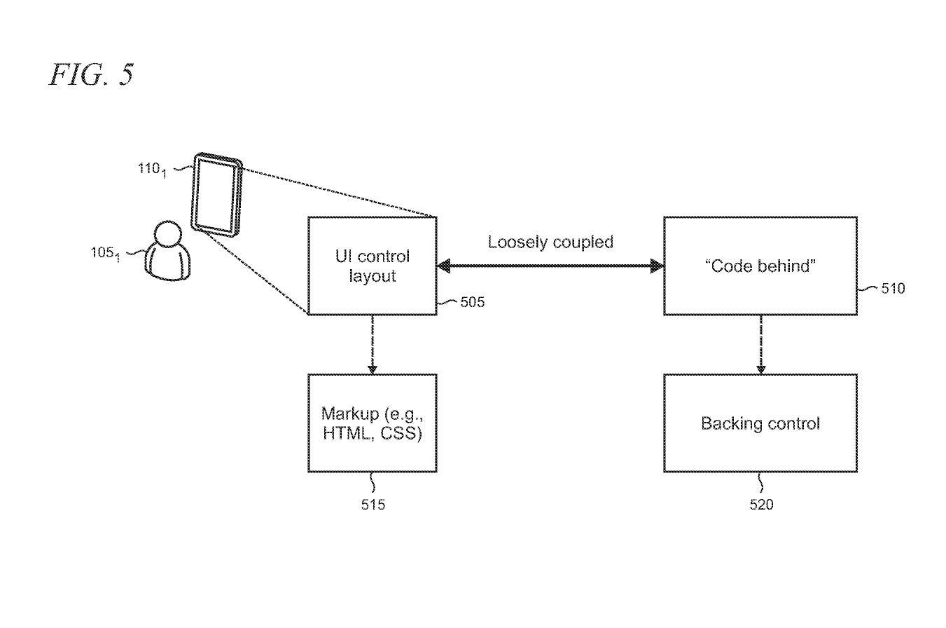

With traditional development models, designers may need to touch code when creating or modifying an application feature which can often be problematic given the designer's more limited code expertise. The tight coupling between code and layout can also give rise to a need to generate relatively large amounts of boilerplate code for each UI control. FIGS. 3 and 4 provide an illustrative example of such boilerplate code in WinJS. WinJS provides comprehensive functionalities to enable designers, programmers, and developers to implement new controls designed for Metro style applications (“apps”) using JavaScript. Presently, WinJS uses a simple but powerful contract between HTML markup and JavaScript to define UI controls. An illustrative fragment of HTML markup for UI controls that displays various music tracks that may be purchased by pushing respective buttons is shown by reference numeral 305 in FIG. 3. The corresponding JavaScript code is shown by reference numeral 405 in FIG. 4.

As shown in this example, even with a relatively simple control, there is a large amount of boilerplate code where such code will typically need to be repeated for virtually every UI control. This situation can lead to the programmer (e.g., programmer 140 in FIGS. 1 and 2) needing to solve similar problems multiple times which can lead to coding errors and inconsistencies, reduce the prevalence of common and shared coding patterns, and ultimately result in higher application maintenance costs.

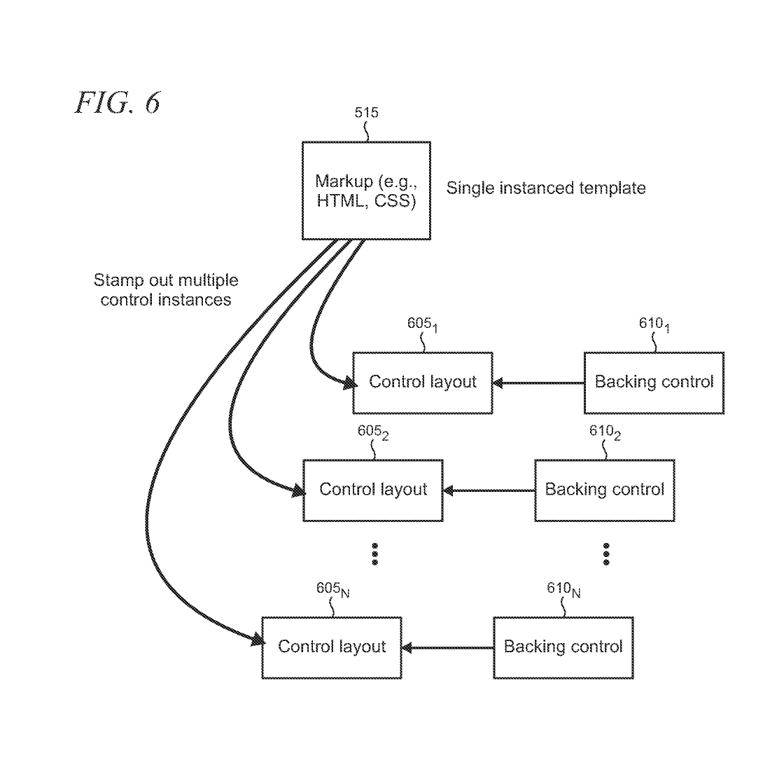

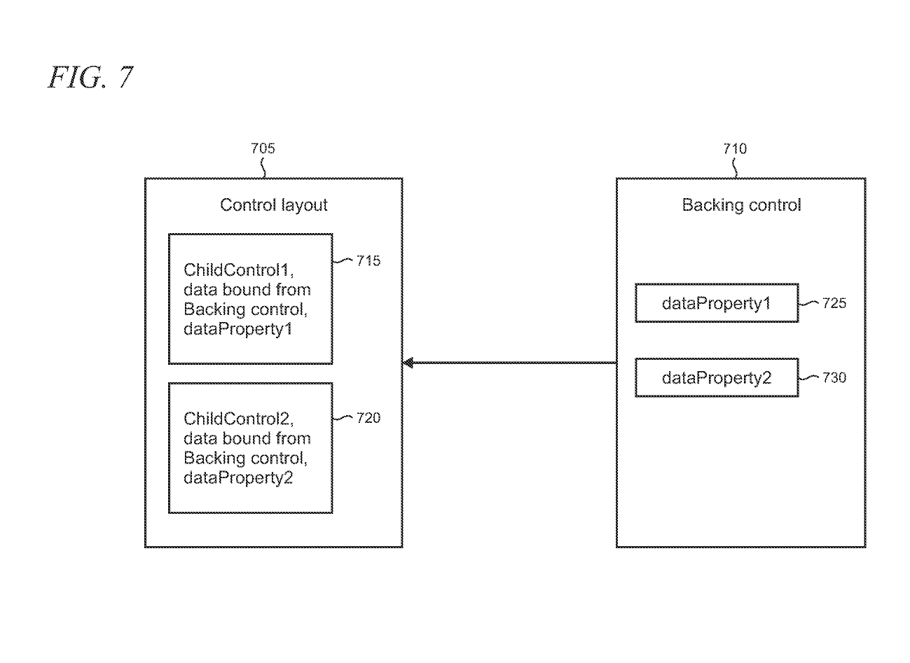

Unlike the tight coupling in traditional UI control models, the UI control layout 505 is loosely coupled to the code behind 510 in the present UI control framework, as shown in FIG. 5. In particular, the loose coupling enables a markup file 515 which, for example, may include HTML and CSS, to be separated from the backing control 520. UI controls store their layout in the markup file 515, including references to any child controls, which is then used as a declarative template to “stamp out” the layout for multiple controls. As shown in FIG. 6, the markup file 515 (i.e., the declarative template) itself is single instanced, but the stamping out is performed on a per control instance. Each layout 605 is mapped on a 1:1 basis to code in the backing control 610. Accordingly, the present UI control framework advantageously enables multiple UI controls to be defined in a single template which eliminates the need for repetitive generation of boilerplate code while enabling simple declarative layout of the controls through the markup.

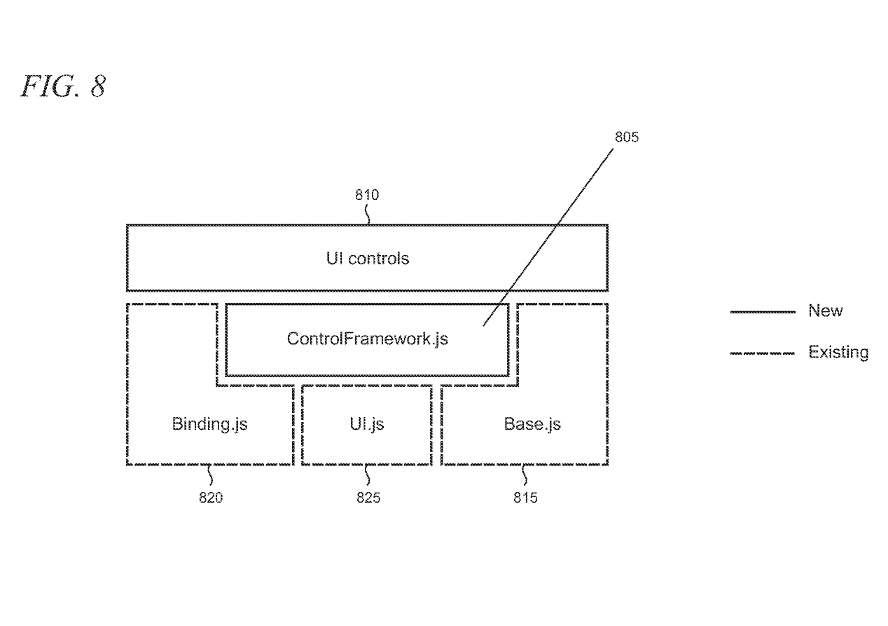

Data for a UI control, such as a property or value, is not directly managed by a control in the layout. Instead, the data is requested through declarative specification in the layout to loosely source the data from the backing control. FIG. 7 shows an illustrative example of such databinding in which a control layout 705 includes two child controls, as indicated by reference numerals 715 and 720. Data for the child controls is bound from the backing control 710 which offers up properties, as indicated by reference numerals 725 and 730. Significantly, the loose coupling allows the data offered up by the backing control to be accomplished abstractly without explicit knowledge of the child controls.

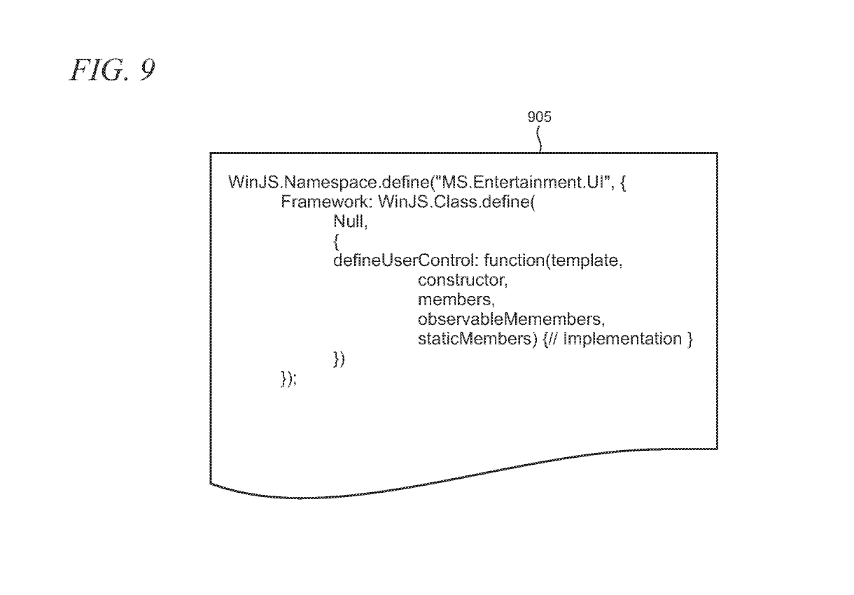

FIG. 8 shows an illustrative architecture for one particular implementation of the present UI control framework which is built on the existing WinJS platform. Additional information about WinJS may be found at http://msdn.microsoft.com/en-us/library/windows/apps/br211377.aspx. In this particular example, the control framework 805 supports UI controls 810 and builds upon three WinJS components as core building blocks. The components include Base.js (as indicated by reference numeral 815) which is the WinJS type library that provides type definition and supports an asynchronous deferred invocation model using a WinJS promise object. The Binding.js component 820 is utilized to provide a declarative and imperative binding system for one-way, dynamic property binding, and data templating. The UI.js component 825 provides the basic control model, an HTML fragment loader, and various UI utility functions. It is emphasized that the utilization of the WinJS platform and its particular building block components is intended to be illustrative and that the present UI control framework is not limited to WinJS platform implementations. The principles presented herein may be adapted for use with a variety of programming paradigms (some of which may not utilize CSS and JavaScript objects) depending on the requirements of a particular implementation.

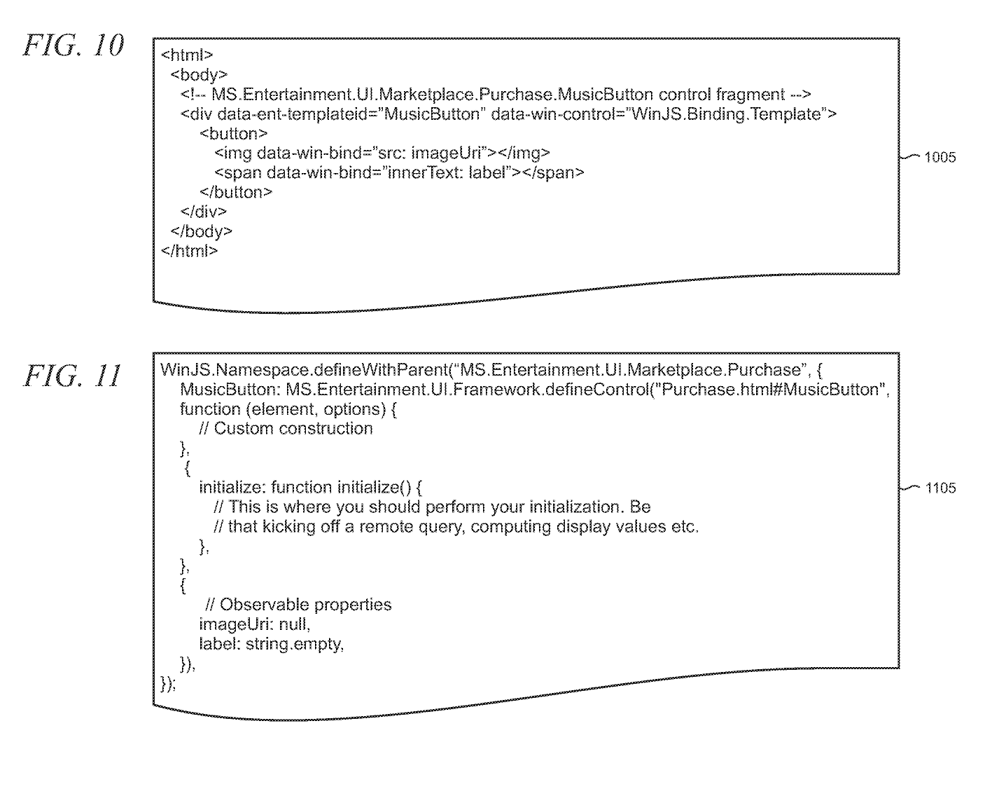

A namespace and a default control class are defined in WinJS as shown in the code segment 905 shown in FIG. 9. This class provides a set of functions that are arranged to simplify control declaration, as well as encapsulate some of the optimizations, and background management of fragments, templates, and the like. The new control class is used instead of the WinJS control definition function. However the defineUserControl function provided conforms to the same WinJS control contract. The function passes many of the parameters into WinJS.Class.define( ) from WinJS, along with passing the values to the default control class.

The function parameters are shown in Table 1 below:

TABLE 1

| Parameter | Description |
|---|---|
| Template | The URI to the template for this |
| | control, e.g. File.html#data-winent- |
| | templateId |
| Constructor | Constructor function, if needed for |
| | this object |
| Members | JavaScript object syntax for |
| | properties, methods that are |
| | members of this control |
| ObservableMembers | Properties on the object that we |
| | would like to bind to from the |
| | control template, and that will |
| | change during the lifetime of the |
| | object |
| StaticMembers | Passed through to the |
| | WinJ.Class.define method |
| Return value | The object that is created |

It is noted that it is possible to derive from an existing control. The common usage in this case would be to employ a different template for the same control behavior. Such usage is similar to the control implementation in Windows Presentation Foundation (“WPF”).

A control base class implements the WinJS contract (e.g., setOptions, setElement, and function (element, options) constructor function), while providing optional customization for designers and programmers extending this class. The control base class supports various functions as shown in Table 2 below:

TABLE 2

| Function | Description |
|---|---|
| initialize | Called after all WinJS level |
| | processing has happened, and the |
| | fragment has been loaded, and the |
| | template processed. |
| | This method will be called in |
| | bottom up order, that is to say the |
| | composed child controls will have |
| | their initialize called before their |
| | parent. |
| | Note, initialize is only called after |
| | the template for that control has |
| | been loaded. |
| Unload | This allows a control to perform |
| | clean up when the control is |
| | removed from the UI. |

There may be occasions when a control author needs to perform work when the author's control is removed from the UI, for example to either free resources, or persist state. To enable this, if a control is removed from the HTML DOM (Document Object Model), then a method called ‘unload’ is called on the control instance. This allows the author to do the work at the right time.

When a template is loaded, it is encapsulated so that the loading of the markup and CSS that implement a UI control is transparent to the control consumer (e.g., the designer 135). To enable this transparency, the control definition will have a URI (Uniform Resource Identifier) that represents both the file, and the identifier within that file for the template. An illustrative example is: “SimpleControls.html#EditBox” as shown in Table 3 below.

TABLE 3

| Part | Description |
|---|---|
| SimpleControls.html | The package-relative path to the |
| | HTML file containing this |
| | template. |
| EditBox | The template identifier within the |
| | HTML file for this control. |

It could be possible to utilize the HTML id attribute to identify the specific template, but there are some issues around uniqueness when merged with the parent document. To resolve this, a custom HTML expando attribute ‘data-ent-templateid’is utilized which is set to a value unique within an HTML document. The combination of file path and id may be used to identify the template globally.

Given the one-to-many relationship of control layout files to templates, the loading of a specific file (fragment) into the DOM for access to the templates needs to be transparent to the control consumer. WinJS has a rich and full featured fragment loading mechanism which can be leveraged by the present UI control framework. This allows fragments to be loaded into the document, and they reside in the document until explicitly unloaded. Subsequent calls to load the same fragment will thus be completed immediately. This implicit caching thus manages the fragments as they are loaded. In addition the instantiated WinJS.Binding.Template instances are cached so they do not need be fetched every time a control is rendered.

The CSS and scripts that are included in the source HTML file are merged, without duplication into the parent document. WinJS provides the ability to ‘unload’ the fragment, which will remove and unload the content. Templates will use the WinJS.Binding.Template( ) function (which conforms to the control contract) in WinJS to perform the actual template hydration for the control, and data binding. Thus, both fragment loading, and template hydration will be handled seamlessly for the control author.

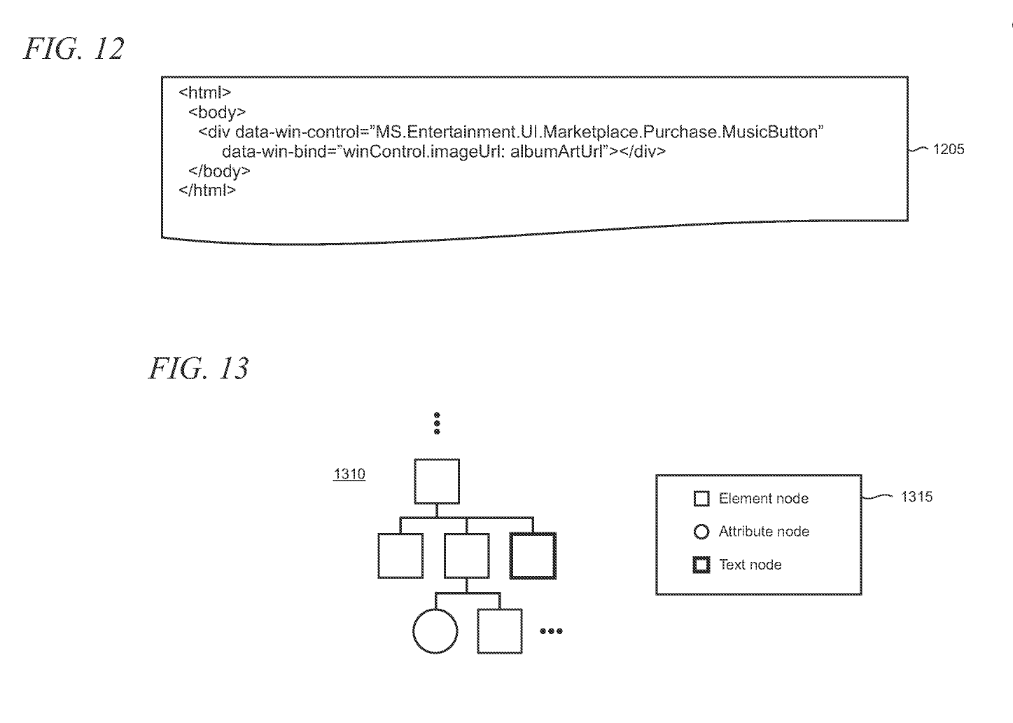

FIGS. 10-12 show an example of an illustrative usage of the present UI control framework. FIG. 10 shows a fragment of HTML code 1005 for a UI control template that implements a UI for enabling a user to purchase displayed music tracks via button pushes in a similar manner to the example shown in FIGS. 3 and 4 and described in the accompanying text. The corresponding JavaScript code 1105 is shown in FIG. 11. A control consumer may simply declaratively instantiate the UI control using the HTML fragment 1205 shown in FIG. 12.

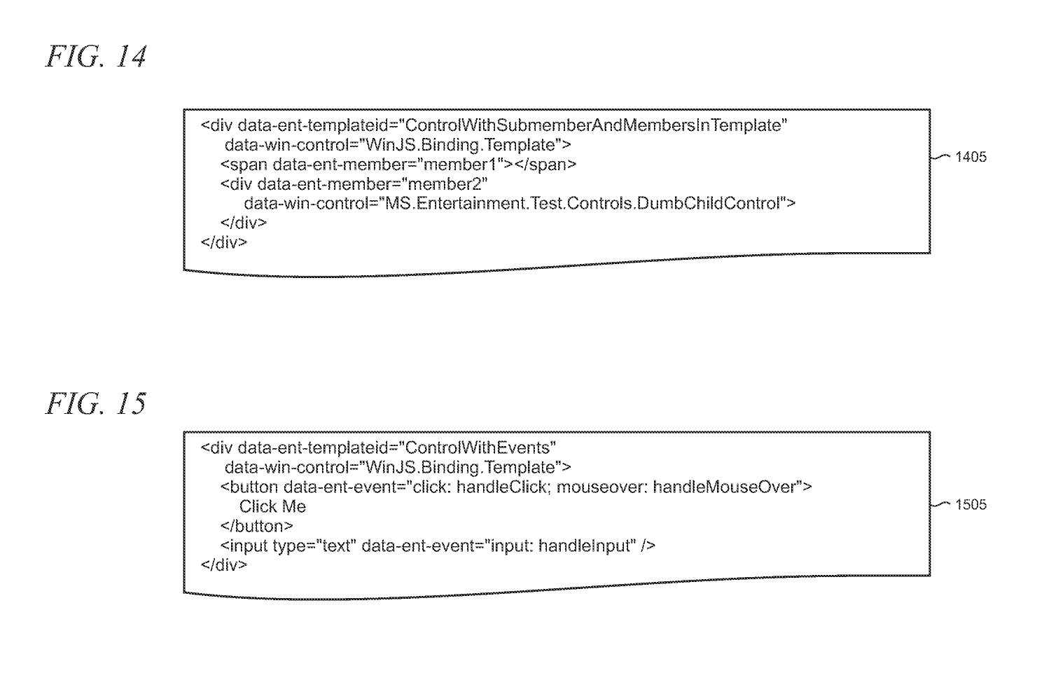

In addition to the core functionality of the UI control framework described above, a number of custom HTML expando attributes may be utilized that provide for additional control behaviors. One particular issue addressed by the attributes is that for a given control's DOM tree, it may need access to specific HTML elements—either directly or through the control represented by that element. An illustrative DOM tree 1310 is shown in FIG. 13 which represents a page of an application as a group of connected nodes which include HTML elements, text elements, and attributes as indicated in the key 1315. JavaScript can access the nodes through the tree to modify or delete their contents and create new elements. The nodes in the DOM tree have a hierarchical relationship to each other.

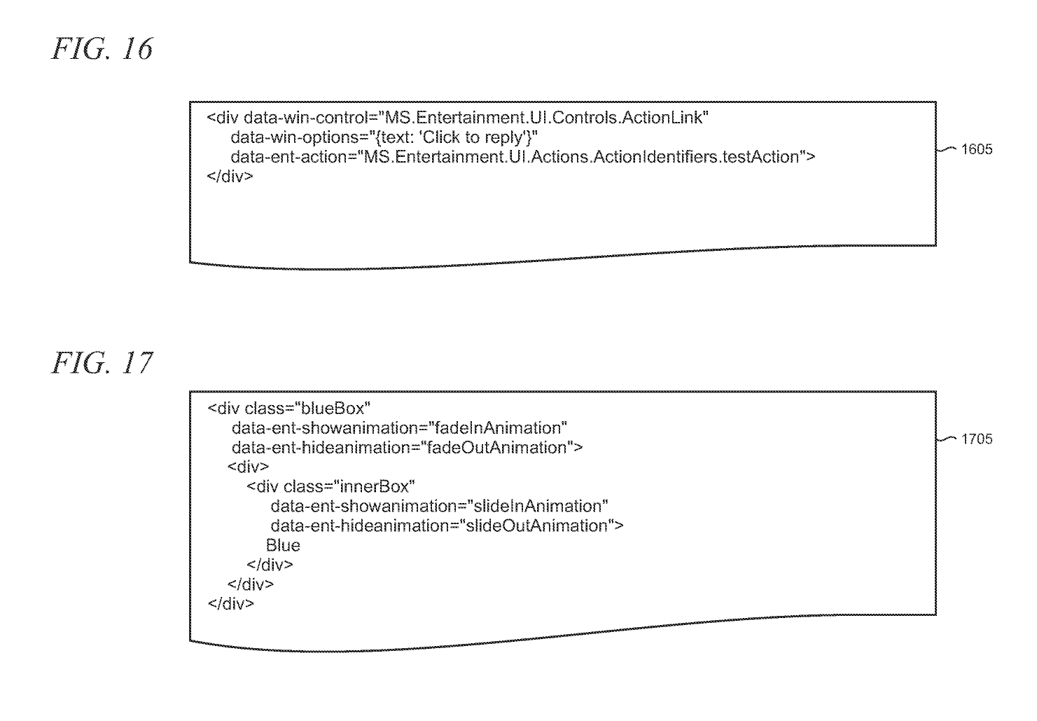

To address this access issue, a template is allowed to be authored where an expando attribute named ‘data-ent-member’ is placed on certain elements. This attribute is interpreted to place the instance of the element it is placed on as a member on the control instance. If the element represents a control, then instead of the element, the control instance is placed in that member. An example is shown in the HTML fragment 1405 shown in FIG. 14. In this example, the control that consumes this template would find that it has two properties set—member1, member2—that enable easy access to those elements. The properties are described in Table 4 below.

TABLE 4

| Name | Description |
|---|---|
| Member1 | This is the Span element directly. It |
| | can be used to set content, add CSS |
| | styles, etc. |
| Member2 | This is the DumbChildControl |
| | instance, not the HTML div |
| | element. The control can access the |
| | DumbChildControl instance |
| | directly. If it requires the DOM |
| | element, it can use the domElement |
| | property on the DumbChildControl |
| | to get that value. |

Given the complexity of a typical DOM tree, and the goal to decouple the layout (i.e., HTML, CSS) from the code implementation as much as possible, events are attached declaratively rather than using code and implementing an event listener. While the ‘data-ent-member’ attribute allows the constituent parts of the template to move and maintain low impact on the code, it still requires calls to the event listener, defined functions, etc. Additionally, the ‘this’ pointer points to the element raising the event not the control itself. This typically means developers are using ‘liar that’, or doing .bind(this) throughout their code. To avoid developers having to concern themselves with such formalities and write the event handlers just like any other function, the expando attribute ‘data-ent-event’ is utilized as shown in the HTML fragment 1505 in FIG. 15. In this particular example shown in FIG. 15, the DOM events that will be attached to the HTML elements are shown below in Table 5.

TABLE 5

| Element | DOM Event | Handler |
|---|---|---|
| Button | Click | handleClick |
| Button | Mouseover | handleMouseOver |
| Input | Input | handleInput |

All the handler methods will be found on the control instance and will have their ‘this’ pointer set to the control instance. When called, they will pass the standard parameters passed to any DOM Event handler.

An additional need is to abstract away certain operations in an application—for example, playing a video, purchasing a track, etc.—to hide the complexity of the operation from the control consumer. To resolve this, a concept called ‘actions’ is created. This concept provides a simple contract for the states of invocation, enabled (e.g. has a valid selection), and available (cannot ever happen based on machine configuration, or market requirements).

While the present UI control framework does not handle the actual invocation of the functionality itself (as it is up to the control to determine the best interaction) the infrastructure of getting an action, handling availability, and making it available to a control is part of the control framework. Accordingly, the expando attribute ‘data-ent-action’ is utilized as shown in the HTML fragment 1605 in FIG. 16. In this example, value of the ‘data-ent-action’ attribute is used to look up the action in an internal service and place the instance on to the actual control. The control can then assume that the action property, if truthy, is a valid action and data bind, or otherwise manipulate it.

Animations are often utilized to produce a compelling set of experiences for users. To enable a consistent, compelling experience, rather than simply elements appearing on the screen as jarring visual flashes, an objective of the present UI control framework is to have controls reveal themselves. Rather than have the controls manage this individually on a case by case basis, the expando attributes of ‘data-ent-showanimation’ and ‘data-ent-hideanimation’ may be used to declare CSS animations that are played on a given element when it is respectively shown and/or hidden. It should be noted that ‘shown’ takes into account the possibility that the element may believe itself to be visible, but because of the visibility of parent elements may not actually be visible. This means that these animations should only be played when the element actually becomes visible, when taking into account the tree it resides in. Additionally, as well as having these animations play automatically when being shown or hidden, there needs to be a way to explicitly start them. Primarily this will revolve around functions intended as drop in replacements for the known [remove|insert|append] Child functions from the DOM. A full set of functions and corresponding descriptions are shown in Table 6 below.

TABLE 6

| Function | Description |
|---|---|
| showElement | Shows the element subtree playing |
| | animations for elements as |
| | appropriate. |
| hideElement | Hides the element subtree, playing |
| | animations for elements as |
| | appropriate. |
| appendChild | Inserts the supplied subtree, in a |
| | hidden state, and plays the show |
| | animation. |
| insertBefore | Same as appendChild, but order is |
| | same as document.insertBefore. |
| removeChild | Plays the hide animation for the |
| | subtree, and once the animation is |
| | complete removes the element from |
| | the subtree. |
| replaceChild | Removes an element subtree with |
| | the hide animation, and inserts the |
| | new element playing the show |
| | animation. |

An illustrative example of animation handling is shown in the HTML fragment 1705 in FIG. 17. In his example, there two show animations on two HTML elements. When these elements become visible, they will invoke the animation applied to the elements where the attributes are set, allowing the developer to avoid having to manage animations playing themselves. Additionally, with this animation functionality, there is programmatic control over the visibility. Specifically there is a ‘visibility’ boolean property that will play the appropriate animation for being shown/hidden—being a property, this allows for easy data binding to control visibility.

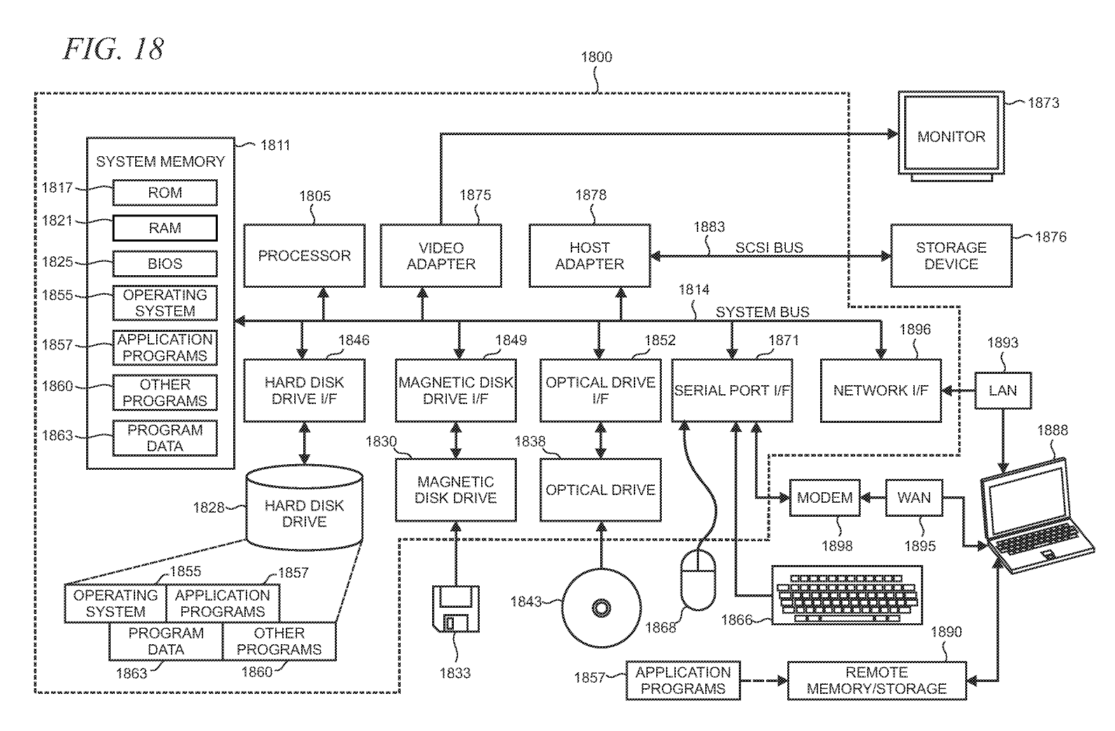

FIG. 18 is a simplified block diagram of an illustrative computer system 1800 such as a PC or web server or other server with which the present UI control framework may be implemented. Computer system 1800 includes a processor 1805, a system memory 1811, and a system bus 1814 that couples various system components including the system memory 1811 to the processor 1805. The system bus 1814 may be any of several types of bus structures including a memory bus or memory controller, a peripheral bus, or a local bus using any of a variety of bus architectures.

The system memory 1811 includes read only memory (“ROM”) 1817 and random access memory (“RAM”) 1821. A basic input/output system (“BIOS”) 1825, containing the basic routines that help to transfer information between elements within the computer system 1800, such as during start up, is stored in ROM 1817. The computer system 1800 may further include a hard disk drive 1828 for reading from and writing to an internally disposed hard disk (not shown), a magnetic disk drive 1830 for reading from or writing to a removable magnetic disk 1833 (e.g., a floppy disk), and an optical disk drive 1838 for reading from or writing to a removable optical disc 1843 such as a CD (compact disc), DVD (digital versatile disc), or other optical media. The hard disk drive 1828, magnetic disk drive 1830, and optical disk drive 1838 are connected to the system bus 1814 by a hard disk drive interface 1846, a magnetic disk drive interface 1849, and an optical drive interface 1852, respectively.

The drives and their associated computer-readable storage media provide non-volatile storage of computer readable instructions, data structures, program modules, and other data for the computer system 1800. Although this illustrative example shows a hard disk, a removable magnetic disk 1833, and a removable optical disk 1843, other types of computer-readable storage media which can store data that is accessible by a computer such as magnetic cassettes, flash memory cards, digital video disks, data cartridges, RAMs, ROMs, and the like may also be used in some applications of the present UI control framework. In addition, as used herein, the term computer readable medium includes one or more instances of a media type (e.g., one or more magnetic disks, one or more CDs, etc.).

A number of program modules may be stored on the hard disk, magnetic disk 1833, optical disk 1843, ROM 1817, or RAM 1821, including an operating system 1855, one or more application programs 1857, other program modules 1860, and program data 1863. A user may enter commands and information into the computer system 1800 through input devices such as a keyboard 1866 and pointing device 1868 such as a mouse, or via voice using a natural user interface (“NUI”) (not shown in FIG. 18).

Other input devices (not shown) may include a microphone, joystick, game pad, satellite disk, scanner, or the like. These and other input devices are often connected to the processor 1805 through a serial port interface 1871 that is coupled to the system bus 1814, but may be connected by other interfaces, such as a parallel port, game port, or universal serial bus (“USB”). A monitor 1873 or other type of display device is also connected to the system bus 1814 via an interface, such as a video adapter 1875.

In addition to the monitor 1873, personal computers typically include other peripheral output devices (not shown), such as speakers and printers. The illustrative example shown in FIG. 18 also includes a host adapter 1878, a Small Computer System Interface (“SCSI”) bus 1883, and an external storage device 1876 connected to the SCSI bus 1883.

The computer system 1800 is operable in a networked environment using logical connections to one or more remote computers, such as a remote computer 1888. The remote computer 1888 may be selected as another personal computer, a server, a router, a network PC, a peer device, or other common network node, and typically includes many or all of the elements described above relative to the computer system 1800, although only a single representative remote memory/storage device 1890 is shown in FIG. 18.

The logical connections depicted in FIG. 18 include a local area network (“LAN”) 1893 and a wide area network (“WAN”) 1895. Such networking environments are often deployed, for example, in offices, enterprise-wide computer networks, intranets and the Internet.

When used in a LAN networking environment, the computer system 1800 is connected to the local area network 1893 through a network interface or adapter 1896. When used in a WAN networking environment, the computer system 1800 typically includes a broadband modem 1898, network gateway, or other means for establishing communications over the wide area network 1895, such as the Internet. The broadband modem 1898, which may be internal or external, is connected to the system bus 1814 via the serial port interface 1871.

In a networked environment, program modules related to the computer system 1800, or portions thereof, may be stored in the remote memory storage device 1890. It is noted that the network connections shown in FIG. 18 are illustrative and other means of establishing a communications link between the computers may be used depending on the specific requirements of a particular application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for implementing a user interface (“UI”) control framework, the method comprising the steps of:
generating a markup document comprising Cascading Style Sheet (“CSS”) and Hypertext Markup Language (“HTML”) code, the document i) including an inline declarative definition of at least one UI control and its layout and ii) being utilized as a single instanced template;
stamping out multiple UI control instances using the template;
generating a backing control for each UI control instance on a one-to-one basis; and
utilizing an expando attribute associated with an HTML element in the template, the attribute placing named properties on a control instance so that the backing control may directly access any child UI control in the layout.

2. The method of claim 1 in which the HTML is HTML revision 5 (“HTML5”) and the CSS is CSS level 3 (“CSS3”).

3. The method of claim 1 in which the HTML element represents a UI control.

4. The method of claim 1 in which the backing control is implemented using JavaScript.

5. The method of claim 1 in which the UI control framework is architected to sit on top WinJS components.

6. The method of claim 5 in which the WinJS components include Binding.js, UI.js, and Base.js.

7. The method of claim 1 in which the attributes enable anchor points to be defined in the markup document.

8. The method of claim 7 in which a layout is revised while maintaining names of the anchor points throughout the revision.

9. One or more computer-readable storage media, not consisting of a propagated signal, storing instructions which, when executed by one or more processors disposed in an electronic device, perform a method for binding data to a user interface (“UI”) control, the method comprising the steps of:
loosely coupling a backing control to a UI control layout by creating a HyperText Markup Language (“HTML”) file that is separate from the backing control, the HTML file being utilized by the UI control for storing its layout and references to any child controls;
stamping out the layout for the UI control using the HTML file as a template; and
enabling the layout to declaratively request data to be bound to the UI control and any child controls from the loosely coupled backing control.

10. The one or more computer-readable storage media of claim 9 in which the template is single instanced and the stamping out is performed on a per UI control instance.

11. The one or more computer-readable storage media of claim 9 in which a backing control is mapped to a stamped out layout on a one-to-one basis.

12. The one or more computer-readable storage media of claim 9 in which the layout is loosely coupled to business logic underlying an application that implements the UI control.

13. The one or more computer-readable storage media of claim 9 in which a set of expando attributes are associated with HTML elements in the template, the attributes placing named properties on a control instance so that the backing control may directly access any child UI control in the layout.

14. The one or more computer-readable storage media of claim 9 in which the application is a web application operable on a remote client device comprising one of mobile phone, e-mail appliance, smart phone, non-smart phone, PDA, PC, notebook PC, laptop PC, ultra-mobile PC, tablet device, tablet PC, handheld game device, game console, digital media player, digital camera, GPS navigation device, Internet-connect television, set-top box, or device which combines one or more features thereof.

15. A system for stamping out user interface (“UI”) controls from a template file including Cascading Style Sheets (“CSS”) and HyperText Markup Language (“HTML”) markup, the system comprising:
one or more computer-readable storage media; and
a processor responsive to the computer-readable storage media and to a computer program, the computer program, when loaded into the processor, operable for
i) exposing an interface to a user to enable the user to declaratively specify UI controls inline with the HTML markup,
ii) generating an HTML file as a single-instanced template storing a layout for the specified UI controls and references to child controls,
iii) stamping out UI control instances using the template.

16. The system of claim 15 in which the user is a web application designer or developer.

17. The system of claim 15 in which the computer program is further operable for executing a backing control for each UI control instance, the backing control being implemented using JavaScript.

18. The system of claim 17 in which a backing control offers up data for binding to a UI control or child control, the backing control providing the data abstractly without direct knowledge of the child control.

19. The system of claim 17 in which the UI control and backing control are implemented in separate files that are loosely coupled.

20. The system of claim 17 in which the HTML file includes anchor points specified using one or more expando attributes associated with HTML elements in the file.
